(19) United States
(12) Patent Application Publication
(10) Pub. No.: US 2008/0264180 A1
(43) Pub. Date: Oct. 30, 2008

(54) System and method for measuring volume of ingested fluid

(75) Inventors: Sudhanshu Gakhar, Neenah, WI (US); Shawn Sullivan, Neenah, WI (US); Theodore Tower, Appleton, WI (US); Richard Timmers, Bear, DE (US); Brooke A. Zimmer, Appleton, WI (US); Sridhar Ranganathan, Suwanee, GA (US)

Correspondence Address: Christopher M. Goff (27839);ARMSTRONG TEASDALE LLP, ONE METROPOLITAN SQUARE, SUITE 2600, ST. LOUIS, MO, 63102, US

(73) Assignee: KIMBERLY-CLARK WORLDWIDE, INC., Neenah, WI (US)

(21) Appl. No.: 11/742,084

(22) Filed: Apr. 30, 2007

(51) Int. Cl. G01F 22/00

(52) U.S. Cl. 73/861.18

(57) ABSTRACT

An audio sensor and receiver detect, discriminate and count the number of liquid swallows to determine the volume of fluid ingested.

### FIELD OF THE INVENTION

The present invention generally relates to systems and methods for distinguishing between sounds and, in particular, to systems and methods for determining a volume of ingested fluid by monitoring swallowing sounds.

### BACKGROUND OF THE INVENTION

One of the major concerns of a nursing mother is the verification that her infant has ingested an appropriate amount of breast milk. The ingestion of the appropriate amount of milk provides feedback to the mother on level of hydration, fullness of the infant's stomach, and the infant's general comfort. Solving this problem would allow the mother to feel more secure and confident about the infant's feeding, and could signal a potential problem if the infant is not receiving enough milk.

There is a need for a system and method to monitor fluid intake of an individual and provide an indication of the intake volume so that an assessment can be made about the individual's status and needs.

### SUMMARY OF THE INVENTION

In one form, the invention determines the number of swallows to indicate the volume of fluid ingested. The system and method acoustically monitors the number of times a swallow occurs during feeding using a acoustic sensor coupled with conditioning and processing. By multiplying the number of swallows by the volume per swallow, the total volume of fluid ingested can be determined.

Other objects and features will be in part apparent and in part pointed out hereinafter.

### BRIEF DESCRIPTION OF THE DRAWINGS

FIG. 1 is a block diagram of one embodiment of a system according to the invention.

FIG. 2 is a flow diagram of one embodiment of the instructions for the processor according to the invention.

FIG. 3 is a schematic of one embodiment of a sensor driver according to the invention.

FIG. 4 is a schematic of one embodiment of a band pass filter according to the invention.

FIG. 5 is a schematic of one embodiment of an amplifier according to the invention.

FIG. 6 is a schematic of one embodiment of an A/D converter according to the invention.

FIGS. 7A-7D and 10 are waveform diagrams of one embodiment of a milk swallow according to the invention.

FIGS. 8A-8C are waveform diagrams of one embodiment of a vocalization according to the invention.

FIGS. 9A-9C are waveform diagrams of one embodiment of noise according to the invention.

FIG. 11 is a state diagram illustrating analysis according to the invention.

FIG. 12 is a diagram illustrating microphones in a breast feeding pillow.

Corresponding reference characters indicate corresponding parts throughout the drawings.

### DESCRIPTION OF THE PREFERRED EMBODIMENTS

Newborns consume about 30 to 90 ml (1 to 3 US fluid ounces), and after the age of four weeks, infants consume about 120 ml (4 US fluid ounces) per feed. Each infant is different, and as it grows the amount will increase. The system and method of the invention assists in determining an infant's intake, particularly during breast feeding.

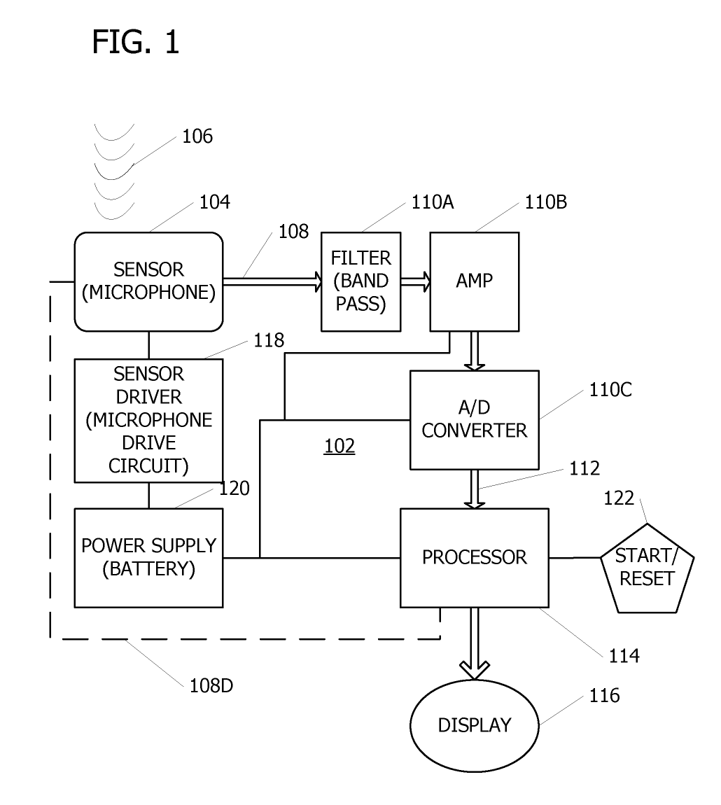

FIG. 1 is a block diagram of one embodiment of a system 102 according to the invention for measuring a volume of a fluid ingested by swallows. An acoustic sensor 104 detects swallow sounds 106 from an infant or other animal during ingestion of the fluid and generates an analog signal 108 corresponding to the detected swallow sounds. (It is also contemplated that a digital sensor generating a digital signal may be employed). A signal conditioning circuit 110 receives the signal 108 and generates a conditioned signal 112 corresponding to the signal 108 from the acoustic sensor. In one embodiment as illustrated in FIG. 1, the conditioning circuit 110 comprises a band pass filter 110A, an amplifier 110B and an analog-to-digital (A/D) converter 110C for generating the digital conditioned signal 112.

A processor 114, such as a microprocessor or a personal computer, receives the conditioned signal 112. Alternatively, the processor 114 may be a DSP (digital signal processor) chip such as TI-6713 manufactured by Texas Instruments, Inc. The processor 114 is programmed with algorithms and/or instructions for discriminating swallowing sounds from other detected sounds and determining a number of swallows indicated by the conditioned signal 112. In addition, the processor 114 is programmed with instructions for calculating the volume of the fluid ingested as a function of the determined number of swallows. An output indicator, such as an audio device or a display 116, driven by the processor 114 provides an indication (such as number of swallows and total volume consumed), which indication corresponds to the calculated volume. It is also contemplated that the A/D converter 111C may be an integral part of the processor 114.

In one embodiment, the sensor 104 may be a digital sensor which directly provides a digital signal 108D to the processor 114 so that signal conditioning circuit is optional and not employed. In this embodiment, the processor 114 would be programmed with filtering instructions.

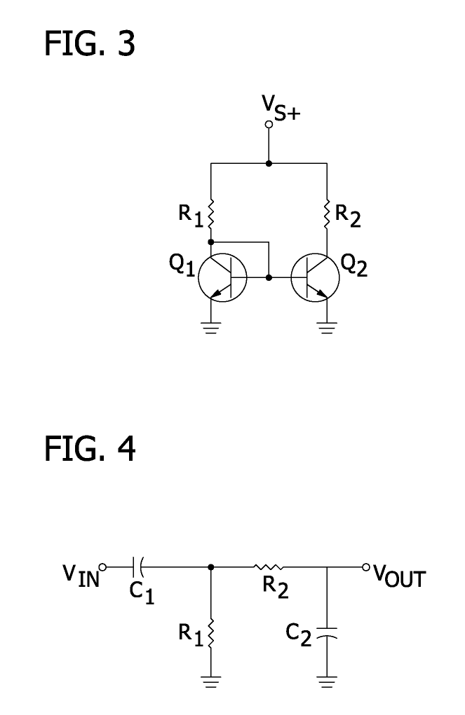

In the event that sensor 104 is a microphone, a sensor driver 118 may be employed to excite its membranes in order to convert mechanical energy to electrical energy. It is contemplated that the sensor driver 118 may be different for various types of microphones. For example, a piezoelectric accelerometer, which requires a constant current source, may be used as the sensor 104. One embodiment of a microphone circuit for a piezoelectric accelerometer is shown in FIG. 3.

Those skilled in the art will recognize that several types of microphones may be used for sensor 104. In one embodiment, contact microphones, or accelerometers, or vibration sensors may be employed because of the higher S/N ratio such devices provide. An example of such an accelerometer is model no. 352C22 manufactured by PCB Piezotronics. Both qualitative and quantitative observations may be used in the course of making a hardware selection for the sensor.

A power supply 120, such as a battery or an external source, may be used to provide power to the components of the system 102. Also, a start/reset device 122 such as a switch or button may be connected to the processor to turn on, reset or turn off the system 102.

In one embodiment, the invention comprises a method for measuring a volume of a fluid ingested by swallows, comprising:
detecting sounds and discriminating swallowing sounds from other detected sounds during ingestion of the fluid;
determining a number of swallows indicated by the detected swallow sounds;
calculating the volume of the fluid ingested as a function of the determined number of swallows; and
providing an indication of the volume ingested corresponding to the calculated volume.

### Qualitative Analysis:

Noise in an acoustic system such as this may be defined as any electronic signal other than the “sound of liquid swallowing”. Hence, as described below, an acoustic signature of vocalization, breathing or air swallowing could also be considered as noise. Although these signatures may have a similar amplitude and frequency range as acoustic signatures of swallowing, it has been found that the sound of swallowing has a very distinct wave shape as observed from time domain and frequency-time domain analysis (see below), as compared to the signature of various noises.

### Quantitative Analysis:

Quantitatively, noise could be defined as background noise or electronic white noise. In some embodiments, the sensor should be selected such that signal 108 corresponding to a swallow has an amplitude which is above this background noise. For example, the S/N ratio can be calculated as:

$$SNR ( dB ) = 10 {log}_{10} ( \frac{{P}_{signal}}{{P}_{noise}} ) = 20 {log}_{10} ( \frac{{A}_{signal}}{{A}_{noise}} )$$

Where P=power and A=amplitude (e.g., current, voltage).

From qualitative analysis and a familiarity of the sensing approaches noted below, a S/N ratio below 10 dB was found to be unidentifiable. Most signals that were identifiable had S/N ratios above 15 dB.

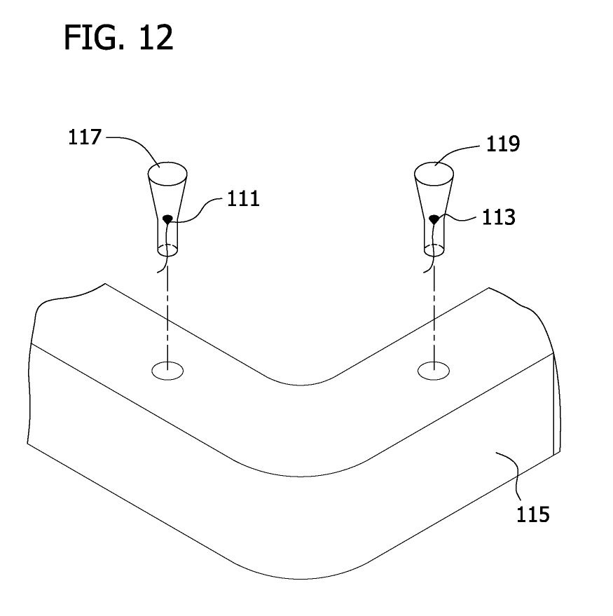

Microphone placement may also be an important consideration when designing such a system 102. In order to develop a base line system and prove feasibility of detecting sounds of swallowing, a piezoelectric accelerometer may be selected. In one embodiment, this accelerometer may be taped on the front of an infant's neck. However, subsequent studies suggest that similar acoustic data could be collected through a condenser microphone placed inside a breast feeding pillow. Thus, as illustrated in FIG. 1, sensor 104 comprises a directional condenser microphone located within a pillow which is adapted to be positioned adjacent an infant ingesting the fluid. For example, as illustrated in FIG. 12, one or plurality of condenser microphones 111, 113 may be located within a pillow 115 which is positioned between an infant's head, neck or body and the breast feeding mother to actively reduce undesired sounds such as ambient noise. Such pillows are frequently used to help position the infant for breast feeding. Alternatively or in addition, either or each of the microphones may be positioned in an acoustic chamber 117, 119 designed for direction selectivity and/or frequency selectivity. The chamber adds directionality and frequency sensitivity to the microphones during use to facilitate detection by the microphone(s) of acoustic sounds or signatures from a particular region of interest while rejecting other undesired sounds, signatures and/or ambient noises. Placement of the microphone within the acoustic chamber may affect the direction or acoustic pattern of the microphone. The shape of the acoustic chamber may affect the frequency selectivity of the chamber. Alternatively or in addition, the chambers 117, 119 may be custom designed to accept the desired sounds or frequency of acoustic signals or reject undesired sounds or frequencies. Alternatively, or in addition, multiple sensors (such as the two microphones 111, 113 illustrated or accelerometers) may be incorporated in the pillow to provides signals which may be used by the processor 114 to implement active noise cancellation to eliminate undesired frequencies, waveforms, acoustic signatures and/or ambient noise.

In one embodiment, a hardware filter such as band pass filter 110A may be employed to eliminate signals outside the desired range of frequency (500 Hz<f<5 kHz). One embodiment of such a band pass filter is shown in FIG. 4.

To prove feasibility, a “Behringer UB802” mixer may be used to filter and amplify acoustic signals. As indicated earlier, acoustic signals of swallowing lie between 500 Hz and 5 kHz. Hence, signals below 500 Hz (i.e., sounds of breathing, heartbeat, etc.) could be eliminated by adjusting the gain of this frequency band to −12 dB. All signals above 5 kHz (i.e. sounds like higher pitch vocalization noises, high frequency electronic noises, etc.) could be eliminated by adjusting the gain of this frequency band to −12 dB. Finally, all signals that belonged within the desired frequency range of 500 Hz-5 kHz were amplified 10-12 dB by the amplifier 110B.

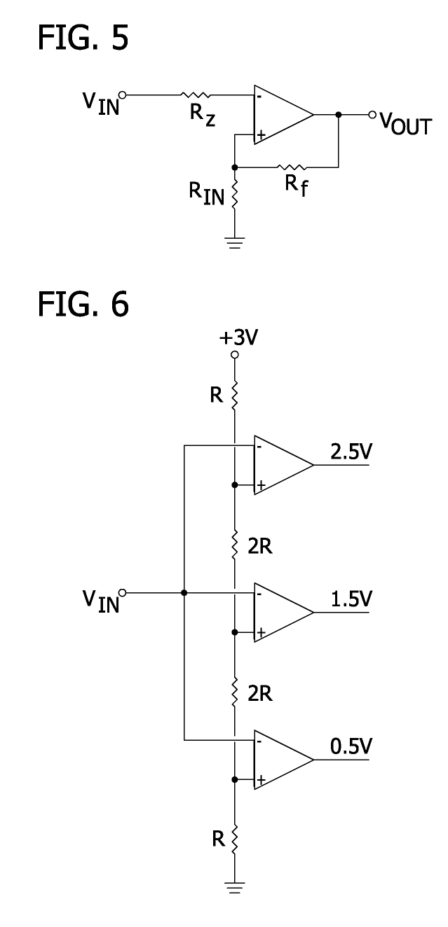

In one embodiment, the amplifier 110B may be configured to amplify the signal within the desired range, such as by using a two stage amplification circuit. Two stage amplification helps in achieving the desired S/N ratio. All signals within the desired frequency range of 500 Hz-5 kHz are amplified 10-12 dB after the band pass filter 110A by a dual stage amplifier such as the amplifier 110B, as illustrated in FIG. 5.

In one embodiment, the analog to digital converter 110C may include a 24 bit sound card. A simplified version of a 2 bit flash A/D converter is shown in the FIG. 6. This data is then recorded in a memory device for data analysis.

### Data Analysis

According to one embodiment of the invention, acoustic data is collected during breast feeding and analyzed to identify the acoustic features of interest and, particularly, the sound of swallowing. The acoustic data may be classified into several categories, including but not limited to:

1) Milk Swallow, including only swallows of a substantial volume of milk;
2) Air Swallow, including dry swallows or other swallows that do not involve the ingestion of milk;
3) Breathing, including inhaling and exhaling;
4) Vocalization, including vocal cord sounds from the infant or others; and
5) Noise, including scratching and other ambient noises.

Each of these categories of data may be analyzed in time and frequency domains. Some of the distinct features observed in these classes are illustrated in figures below.

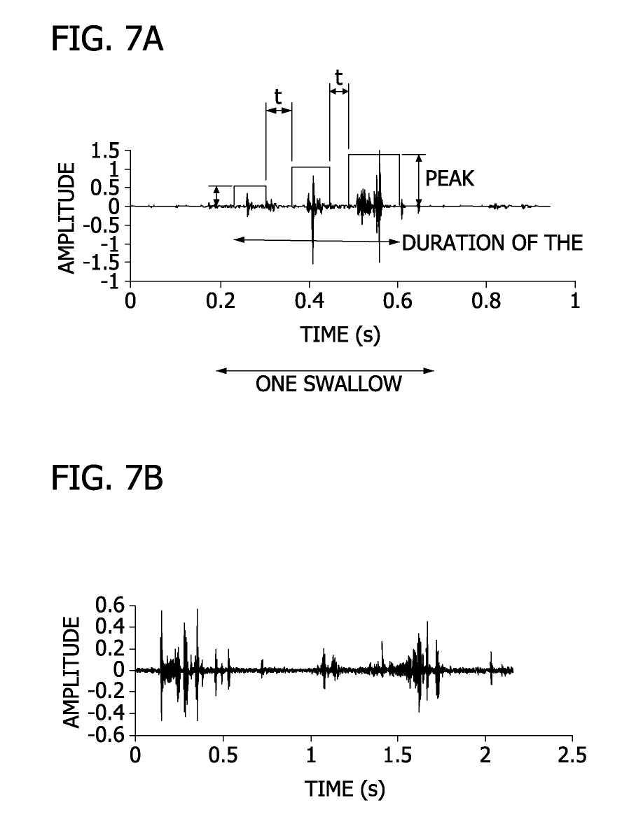

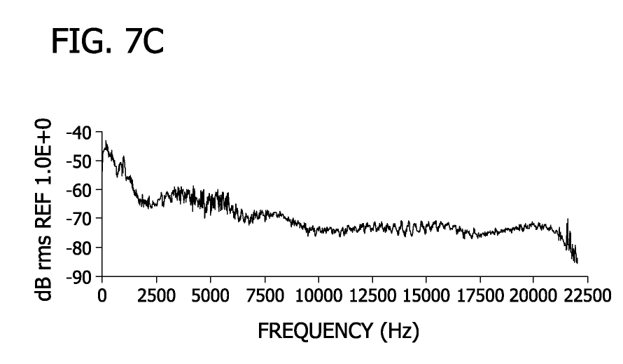

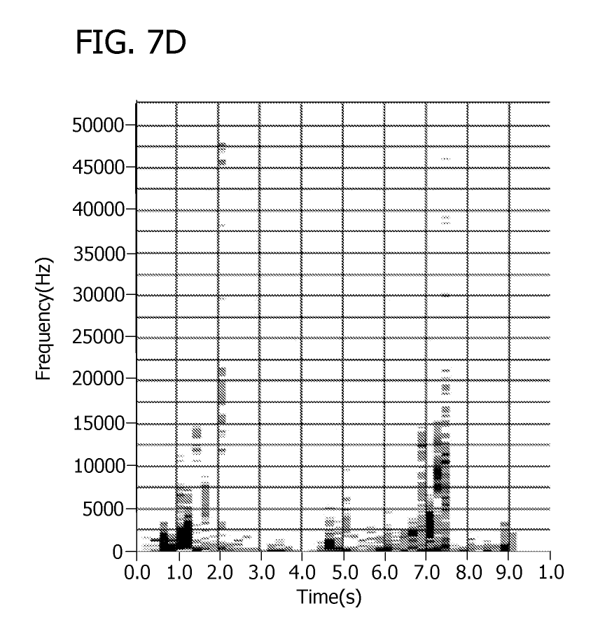

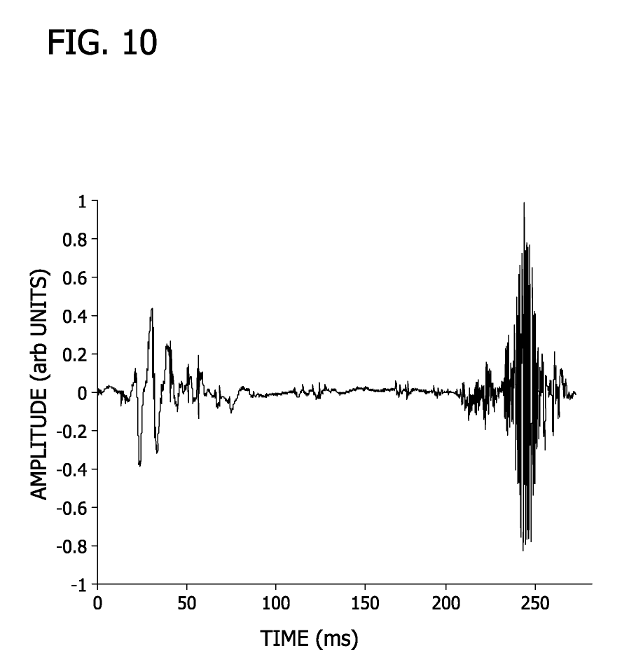

Milk Swallow: In the time domain an acoustic signature of a milk swallow is divided into three distinct parts: a “click”, a “chug” and a “click”, as illustrated in FIGS. 7A-7D and 10. The duration and intensity of each part is a characteristic that may be utilized to identify and distinguish a milk swallow from other noises.

In the frequency domain, it was observed that the sound of swallows fall between 500 Hz-5 kHz. In time and frequency domains, a pattern unique to milk swallow was also observed, as shown in FIGS. 7A-7D and 10.

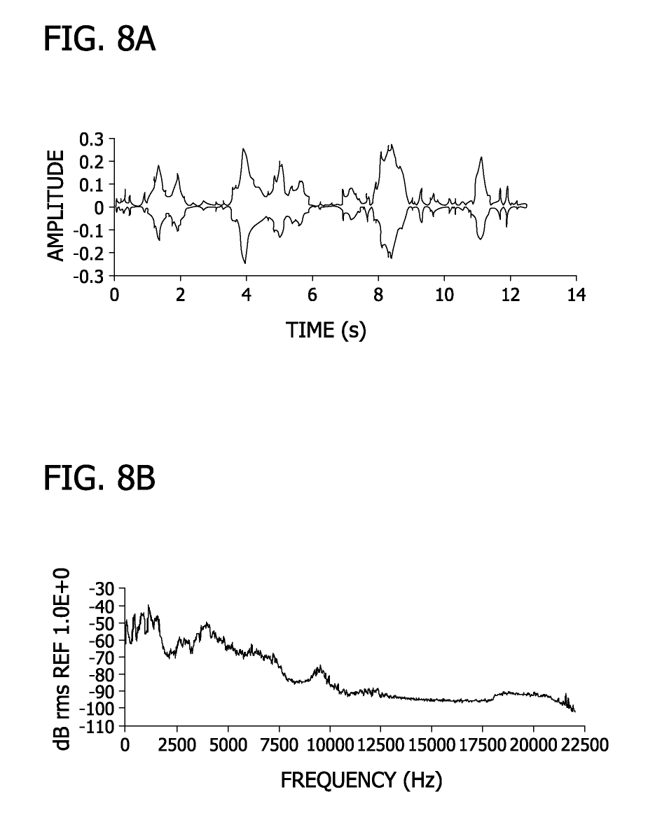

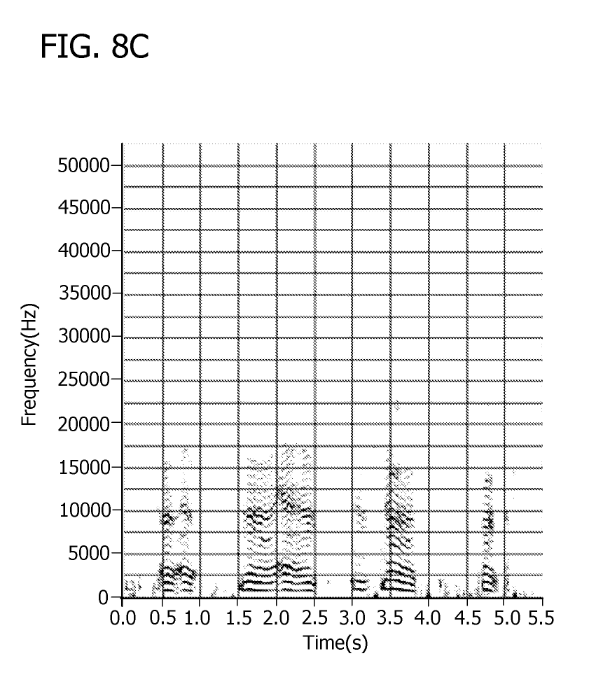

Vocalization: This category of data includes sounds of crying, coughing, etc. Although vocalization was observed to have a similar frequency as milk swallow, it was observed that the waveform of the signal is different in time and frequency-time scales, as shown in FIGS. 8A-8C.

Noise: This category included background noises such has scratching caused due to movement, electronic noise and other signals that could not be classified into categories mentioned above.

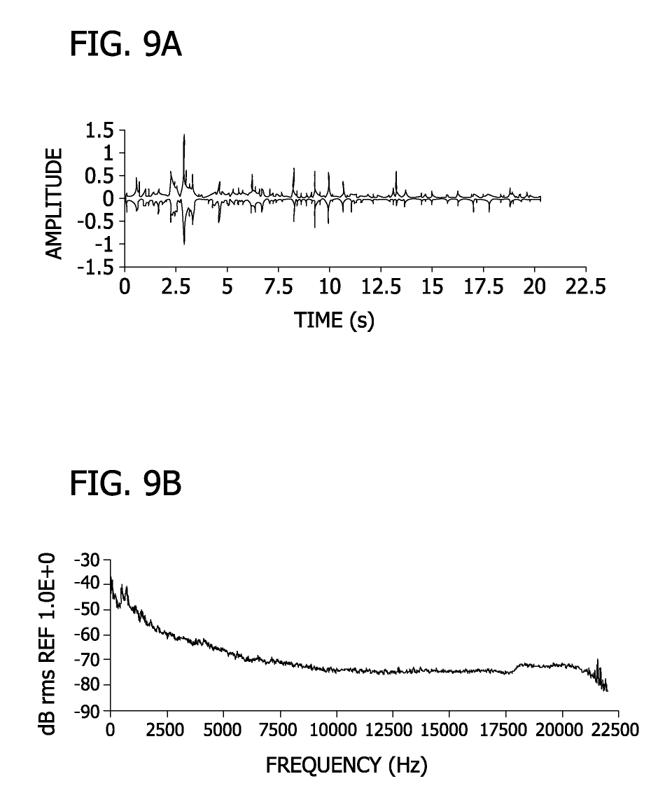

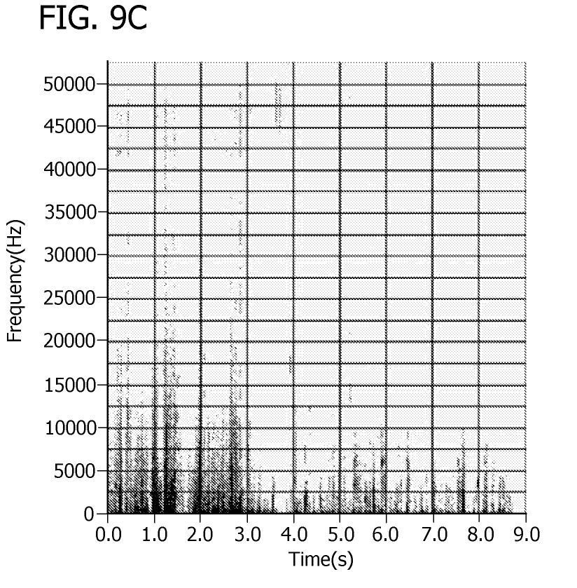

The peak frequency of such signals was different from other categories of acoustic data, as illustrated in FIGS. 9A-9C. While analyzing the complete data set, it was also noted that there may be variations in the acoustic signature of swallowing, such as:

1) variations within different infants;
2) variations with the same infant;
3) microphone placement that affects S/N ratio; and
4) unpredictable ambient noise like scratching, etc.

In one embodiment, the processor 114 may be trained to detect an acoustic signature of milk swallows. Alternatively and in addition, an algorithm based on the observations described above may be used to develop an inclusion criterion for detecting an acoustic signature of milk swallows, as illustrated in FIG. 7A.

Parameters like peak amplitude and duration of a “click”, a “chug” and a “click” were used as parameters as shown in FIG. 7A. These parameters are analogous to a mask that slides over a waveform. As soon as this mask locked onto a desired acoustic characteristic, a fast fourier transform (FFT) of the acoustic signal was computed to verify if the peak frequency was within the desired 500 Hz to 5 kHz range. If all these inclusion criteria were satisfied, a milk swallow was detected. Success criteria for a particular algorithm may be determined by using a validation dataset including sounds of swallowing as well as the other categories described above.

In one embodiment, it is contemplated that sounds of swallowing may be classified using a wave-shape type of algorithm which tends to work well with this type of data set. However, such wave-shape algorithm may be sensitive and could fail when subjected to a highly variable environment. Hence, there may be a need to implement a more robust algorithm

In one embodiment, it is contemplated that sounds of swallowing may be classified using a probabilistic model (e.g., HMM) as noted herein. This computes probability of occurrence of an event/state based on a large training set of data. However, although this algorithm was fairly robust, it may be computationally intensive. Hence, a third approach may be an HMM/ANN hybrid technique including elements from the wave shaping algorithm.

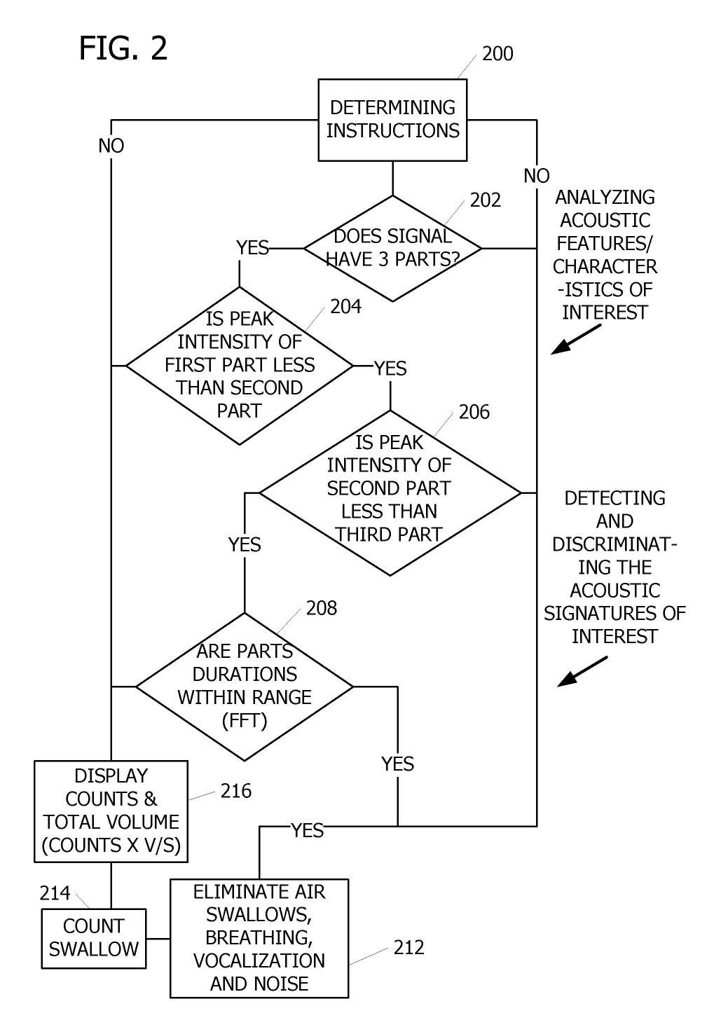

In accordance with the above, the processor 114 executes determining instructions 200 as illustrated in FIG. 2. Initially, the processor 114 analyzes the acoustic features and characteristics of interest. In particular, the processor 114 analyzes the digital signals 112 to find a three part waveform at 202. In some embodiments, the parts may be related to each other. For example, an amplitude or duration of one part may be less than another or the amplitudes or durations may be within a range of ratio with respect to each other. When the three part waveform is found, the peak intensity of each part is analyzed at 204, 206 and 208 to confirm that the waveform corresponds to a swallow as illustrated in FIG. 7A. Next, the processor 114 detects the acoustic signatures of interest. In particular, instructions for finding the frequency range using FFT analysis is executed at 208, and air swallows, breathing, vocalization and noise are eliminated at 212. Swallows are counted at 214 and at 216 the display 116 is updated to indicate the total counts and total volume=total counts×V/S (volume/swallow).

### Automatic Speech Recognition (ASR)

Although developing such algorithms as noted above can be successful in detecting and discriminating sounds of liquid swallows, there are other techniques and/or approaches contemplated for developing an algorithm. One such approach is based on Automatic Speech Recognition (ASR), and uses Hidden Markov Models (HMM) to create instructions for execution by processor 114 that are capable of identifying different sounds present during nursing. For example, other alternatives in use in ASR fall into the areas of discriminate analysis (linear, multiple, non-linear), pattern recognition, and pattern classification. Another such approach is based on artificial neural networks for processing and discriminating sounds of liquid swallows. Another common alternative in ASR is also the use of Artificial Neural Networks (ANN). ANN's are trained on a large body of data, “learning” the patterns of different kinds of signals, and classifying test pattern to the best matching pattern. Once trained, they are computationally efficient and easy to implement. Hidden Markov Models are more complex, but typically are used to handle variable duration signals, such as in swallowing. Both methods are robust to a certain degree of missing features or noise. One contemplated embodiment uses a hybrid of the ANN computational efficiency and the HMM variable duration modes.

The adaptive speech recognition approach uses a large set of data to train a processor for specific parameters. This trained processor can then stochastically predict acoustic signatures of swallowing. This approach is very useful for a large data set with a lot of variations.

In one embodiment, Automatic Speech Recognition (ASR), and Hidden Markov Models (HMM) are used to create instructions that are capable of identifying different sounds present during nursing.

In one approach from two clinical studies, training samples of five classes of sounds were isolated: Milk swallow; Air swallow; Breathing; Vocalization (crying, grunting, etc); and Other. FIG. 10 is an example of one of the milk swallowing sounds. There is usually an Initial Discrete Sound (IDS), often referred to as a “click”, that precedes the transfer of the bolus volume. As such, the IDS may be used as a trigger.

### Common Approaches to Feature Extraction in ASR

Automatic Speech Recognition includes feature extraction approaches which tend to extract and reduce the dimensionality of the speech signal to mediate online processing. The following is a description of one embodiment of an ASR approach using the swallowing sound example illustrated in FIG. 10.

Often the first step in decomposing the spectral content of a speech signal is the Short Time Frequency Transform (STFT), where time is along the x-axis and frequency along the y-axis, with the DC signal at the bottom. In this example, 256 channels are used. A common approach is then to convert these to the cepstral coefficients, typically 12 channels plus one for the power. The cepstral coefficients have the advantage that they are largely uncorrelated, which is advantageous for pattern recognition.

Thereafter, it is common to apply the RASTA algorithm for environmental adaptation and simulating auditory masking. The RASTA output is normally weighted to give higher bands more equal footing with the power. Lastly, it is common to also calculate the “delta-ceps”, namely, the trajectory or direction vector of the coefficients over time, and similarly to weight them with a gain factor.

In typical ASR applications, one may use the RASTA and the delta-ceps together to give a 26-feature vector (13 from each) at each time window, typically 10 ms (100 Hz). However, the adaptation afforded by the RASTA algorithm may diminish the effect of the power levels too severely. Therefore, this current example will only use the first two cepstral coefficients for simplicity and demonstration.

Having extracted the features from the training set, recognition models for different types of sounds are created. In ASR, where there is a large volume of available training data, sub-models are built that recognize short building blocks of words (e.g. phonemes). Because of the limited amount of training data in this example, a recognition model for each training sound is created.

The basis for the models used in this example is the Hidden Markov Model (HMM). Rather than describe the theory, which can easily be found elsewhere, the example will describe an implementation. It is assumed for this example that the process of swallowing consists of a number of states (i.e. of the esophageal opening, contractions, etc) which, in concert, perform the sequential actions of swallowing, but cannot be directly observed—hence, they are referred to as hidden states. Each state has a probability of staying in the current state, or moving into the next state of swallowing. In this way, the model captures variability in duration of each stage. Moreover, each state can result in a variety of sounds (or none!). So, a HMM is a doubly probabilistic model of a system.

In the analysis of sounds to determine swallowing, two of the common problems to which HMM are applied are addressed: 1) learning the parameters of an HMM that fit an observation or group of observations, and 2) recognition of a given observation as belonging to a particular model.

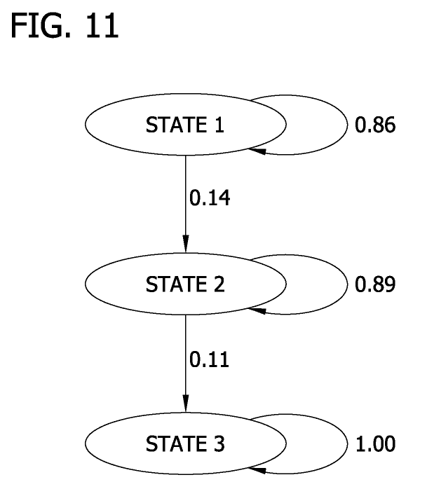

In this example, HMM coefficients were determined from 39 training samples. The HMM states for the example sound is illustrated in FIG. 11. The transition probabilities are shown by the arrows. An arrow looping back on itself indicates that the system remains in the current state. At the end of the sound, the system remains in the last state. Note that this model could be adjusted to detect cyclical sucking, in which there would be an arrow leading back to the first node.

Again, because of the limited sample size, full cross validation, or the “leave one out” method may be performed. For example, the first swallowing sound was tested against all the models, except for the model that was built on this sound. Each of the 39 sounds is subsequently tested in the same way.

For each sound, a model is found which provides a match, and the model class (e.g. one of the milk swallowing models) is compared to the “true” classification of the sound. This gives resulting true and false positives which can be evaluated.

In summary, the system and method of the invention addresses the problem of ambiguity in the amount of milk ingested by an infant during nursing. In one embodiment, the invention comprises a small microphone that would be placed on or near an infant's throat to pick up the audio signal of each swallow and a receiver that gathers the signal and displays a result. The microphone picks up the audio signal from each of the infant's swallows. As noted above, various analog and/or digital audio filtering techniques may be applied so that the receiver is sensitive to the characteristic signal from a swallow. Other external ambient audio signals are ignored to avoid affecting the measurement. The number of swallows during a feeding is counted. The beginning and ending of the feeding may be triggered by a switch or button activated by the mother.

The following non-limiting examples are provided to further illustrate various options of the present invention. There could be several variations of the display and processor. For example, the sensor 104 may be wireless and transmit its signal to the filter 110A or to the processor 114, if the signal is digital. The swallow volume may be tuned or changed depending on the infant's age or size. It is contemplated that the sensor 104 could be enclosed in a soft, loosely held strap located around the infant's neck, or be placed under the infant, or be attached to the infant's clothing, or not contact the infant at all, depending on the sensitivity and selectivity of the sensor and filter. The processor 114 may have an internal memory that stores the fluid volume from previous feedings, allowing the mother to evaluate a longer-term window of feeding and hydration and enabling trend monitoring.

In one example, the display 116 may be provided with a red/green light indicator that turns green as it processes/detects sounds of swallowing. This reassures the mother that feeding is going on properly. This device will not require any user inputs.

In another example, the processor 114 processes sounds of swallowing and the display 116 displays the number of swallows and estimates the volume of milk ingested by multiplying the number of swallows with the average milk ingested by an infant during each swallow. The processor 114 may be programmed to receive specific user inputs like age, weight and/or gender, etc. of the infant in order to adjust the processing of the sounds and/or the calculations. For example, with increased age and/or weight, the average volume per swallow may be increased. Also, the volume per swallow may be different for males and females, also depending on weight and/or age.

One advantage to this acoustic system is that it operates passively and no external signal (such as ultrasound analysis) is transmitted from the system to the infant to monitor swallowing. Thus, the infant does not have to be subjected to any external signals.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

Having described the invention in detail, it will be apparent that modifications and variations are possible without departing from the scope of the invention defined in the appended claims.

What is claimed is:

1. A system for measuring a volume of a fluid ingested by swallows, comprising:
An acoustic sensor detecting sounds including swallowing sounds during ingestion of the fluid and generating a signal corresponding to the detected sounds;
a signal conditioning circuit receiving the signal and generating a conditioned signal corresponding to the signal from the acoustic sensor;
a processor receiving the conditioned signal, said processor including instructions for discriminating swallowing sounds from other detected sounds and determining a number of swallows indicated by the conditioned signal and including instructions for calculating the volume of the fluid ingested as a function of the determined number of swallows; and
a output indicator driven by the processor for providing an indication of the volume ingested corresponding to the calculated volume.

2. The system of claim 1 wherein the acoustic sensor comprises a microphone and wherein the signal conditioning circuit comprises a filter filtering the signal so the conditioned signal does not include frequencies outside a given range.

3. The system of claim 2 wherein the given range is 500 Hz to 5 kHz.

4. The system of claim 3 wherein the acoustic sensor comprises an analog to digital converter for converting the conditioned signal into a digital signal provided to the processor.

5. The system of claim 1 wherein the instructions for determining comprise instructions for analyzing the duration and intensity of the conditioned signal.

6. The system of claim 5 wherein the instructions for analyzing comprise instructions for identifying a swallowing waveform having three parts, wherein each part has a characteristic duration and a characteristic intensity.

7. The system of claim 6 wherein the three parts are related to each other.

8. The system of claim 1 wherein the instructions for determining comprise instructions for applying a FFT to the conditioned signal to determine whether its peak frequency is within a given range.

9. The system of claim 1 wherein the instructions for determining comprise speech recognition instructions employing models for recognizing different sounds during swallowing.

10. The system of claim 8 wherein the speech recognition instructions are adaptive and the models are hidden Markov models.

11. The system of claim 8 wherein the speech recognition instructions distinguish between conditioned signals indicating liquid swallows and conditioned signals indicating at least one of air swallows, breathing and vocalization.

12. The system of claim 1 wherein the acoustic sensor is a directional condenser microphone located within a pillow which is adapted to be positioned adjacent an infant ingesting the fluid and further comprising at least one of the following:
Wherein the microphone is positioned in an acoustic chamber providing direction selectivity and/or frequency selectivity to sounds received by the microphone during use so that desired sounds and/or acoustic signatures from a particular region of interest are detected while undesired sounds, undesired acoustic signatures and/or ambient noises are rejected; and
Wherein the microphone is positioned with an acoustic chamber that accepts desired sounds or rejects undesired sounds; and
Wherein the directional condenser microphone comprises multiple sensors in the pillow and wherein the processor uses the signals from the sensor for active noise cancellation.

13. A system for measuring a volume of a fluid ingested by swallows, comprising:
A digital acoustic sensor detecting swallow sounds during ingestion of the fluid and generating a digital signal corresponding to the detected swallow sounds;
a processor receiving the digital signal, said processor including instructions for determining a number of swallows indicated by the digital signal and including instructions for calculating the volume of the fluid ingested as a function of the determined number of swallows; and
a output indicator driven by the processor for providing an indication of the volume ingested corresponding to the calculated volume.

14. The system of claim 13 wherein the acoustic sensor comprises a microphone and wherein the processor comprises a filter filtering the signal so the digital signal does not include frequencies outside a given range.

15. The system of claim 14 wherein the given range is 500 Hz to 5 kHz.

16. The system of claim 13 wherein the instructions for determining comprise instructions for analyzing the duration and intensity of the digital signal.

17. The system of claim 16 wherein the instructions for analyzing comprise instructions for identifying a swallowing waveform having three parts, wherein each part has a characteristic duration and a characteristic intensity.

18. The system of claim 17 wherein the three parts are related to each other.

19. The system of claim 13 wherein the instructions for determining comprise instructions for applying a FFT to the digital signal to determine whether its peak frequency is within a given range.

20. The system of claim 13 wherein the instructions for determining comprise speech recognition instructions employing models for recognizing different sounds during swallowing.

21. The system of claim 20 wherein the speech recognition instructions are adaptive and the models are hidden Markov models.

22. The system of claim 20 wherein the speech recognition instructions distinguish between digital signals indicating liquid swallows and digital signals indicating at least one of air swallows, breathing and vocalization.

23. A method for measuring a volume of a fluid ingested by swallows, comprising:
Detecting sounds and discriminating swallowing sounds from other detecting sounds during ingestion of the fluid;
determining a number of swallows indicated by the detected swallow sounds;
calculating the volume of the fluid ingested as a function of the determined number of swallows; and
providing an indication of the volume ingested corresponding to the calculated volume.
